(19) United States
(12) Patent Application Publication
(10) Pub. No.: US 2008/0300945 A1
(43) Pub. Date: Dec. 4, 2008

(54) TECHNIQUES FOR SHARING RESOURCES ACROSS MULTIPLE INDEPENDENT PROJECT LIFECYCLES

(76) Inventors: Michel Shane Simpson, American Fork, UT (US); Volker Gunnar Scheuber-Heinz, Pleasant Grove, UT (US); Lee Edward Lowry, Orem, UT (US); William Street, Orem, UT (US)

Correspondence Address: SCHWEGMAN, LUNDBERG & WOESSNER/NOVELL, PO BOX 2938, MINNEAPOLIS, MN, 55402, US

(21) Appl. No.: 11/756,112

(22) Filed: May 31, 2007

(51) Int. Cl. G06Q 10/00

(52) U.S. Cl. 705/8

(57) ABSTRACT

Techniques for sharing resources across multiple independent projects are provided. Resources, which are associated with a first project and which are managed within first stages of a first project lifecycle, are selectively shared and managed within second stages of a second project lifecycle, which is associated with a second project. The first and second project lifecycles are separately and independently managed from one another.

### FIELD

The invention relates generally to data processing and more particularly to techniques for sharing resources across multiple independent project lifecycles.

### BACKGROUND

Increasingly enterprises and governments are turning to technology to automate and streamline their internal operations and business processes. Furthermore, the advent of the Internet and the World-Wide Web (WWW) has allowed enterprises and governments to delivery goods and services in an automated and nearly instantaneous fashion across the entire globe.

With any good or service provided by an enterprise, there can be potentially a myriad of activities and expenses associated with those activities, which the enterprise endures before the good or service is available in the marketplace for consumption.

The activities, which are associated with each good or service, are often collectively managed as a project. This permits expenses and resources to be controlled and managed according to plans and/or budgets, which in turn makes enterprises more efficient and profitable.

Because projects can be complicated and include many automated and manual activities, project management remains largely a human resource intensive exercise. That is, skilled and high salaried individuals are often employed or contracted to manage projects. To a large extent project management is not automated, although there is a plethora of support tools that provide ad hoc assistance to project managers.

Furthermore, enterprises often have many concurrent internal projects going on at a single time. Accordingly, unless different project managers effectively communicate many resources are duplicated and at the same time the duplicated resources are also underutilized.

Thus, what is needed is a mechanism, which allows for automated and improved resource sharing across projects during the project management process.

### SUMMARY

In various embodiments, techniques for sharing resources across multiple independent project lifecycles. More specifically, and in an embodiment, a method is provided for sharing a resource across multiple independent project lifecycles. First resources associated with one or more first stages of a first project are selectively shared with one or more second stages of a second project. The first stages are associated with a first project lifecycle of the first project and the second stages are associated with a second project lifecycle of the second project, and each of the projects is managed independent of one another. Next, the first resources are managed and shared via interdependencies, which are defined for tying some aspects of the first project lifecycle with other aspects of the second project lifecycle. Finally, policy is enforced to drive the management of the interdependencies.

### BRIEF DESCRIPTION OF THE DRAWINGS

FIG. 1 is a diagram of a method for sharing a resource across independent project lifecycles, according to an example embodiment.

FIG. 2 is a diagram of another method for sharing a resource across independent project lifecycles, according to an example embodiment.

FIG. 3 is a diagram of an inter-project resource sharing management system, according to an example embodiment.

FIG. 4 is a diagram of another inter-project resource sharing management system, according to an example embodiment.

### DETAILED DESCRIPTION

A “resource” includes a user, content, a processing device, a node, a service, an application, a system, a schema definition, a directory, an operating system (OS), a file system, a data store, a database, a policy definition, a configuration definition, a file, a World-Wide Web (WWW) service, a WWW page, groups of users, combinations of these things, etc. The terms “service,” “application,” and “system” may be used interchangeably herein and refer to a type of software resource that includes instructions, which when executed by a machine performs operations that change the state of the machine and that may produce output.

In an embodiment, each resource is electronically defined and represented as having one or more attributes. Each attribute includes one or more name value pairs. For example, a server resource may include an attribute associated with its physical Internet Protocol (IP) address and that attribute may be represented by the following name value pair: “IP=100.1.1.10.” The server resource may also have its own identity (discussed below) and may include other attributes such as whether the IP address is static or dynamic, etc. Attributes may also include references to policy or even specific configuration details for a given processing environment that a resource is to be deployed to.

A “project” refers to the activity associated with an enterprise or government producing a good (product) or personal service (e.g., financial advice, etc.) for consumption in the marketplace. The activity for the project is defined in various stages of the project's lifecycle, such as by way of example only project definition, project development, project testing, project release, etc. Thus, a “project” is represented and electronically defined as a series of stages associated with the project's lifecycle. Each stage includes its own processing environment having its own or shared resources. So, a stage is represented and electronically defined as one or more resources and their relationships with other resources of the same stage or a different stage. A project may also be viewed as a type of resource.

A “processing environment” refers to one or more physical processing devices organized within a local network. For example, several computers connected via a local area network (LAN) may collectively be viewed as a processing environment. The processing environment also refers to software configurations of the physical processing devices, such as but not limited to operating system, file system, directory service, etc. A single processing environment may be logically defined, such that it spans multiple different networks (e.g., multiple different LAN's, a LAN and a wide-area network (WAN), etc.).

An “identity service” refers to a special type of service that is designed to manage and supply authentication services and authentication information for resources. So, an identity service may authenticate a given resource for access to a variety of local and external services being managed by that identity service. A single resource may have multiple identity services. In addition the identity service itself may be viewed as a type of resource. In this manner, identity service may authenticate and establish trust with one another viewing one another as specific type of resource.

According to an embodiment, some example identity services are described in “Techniques for Dynamically Establishing and Managing Authentication and Trust Relationships,” filed on Jan. 27, 2004, and having the U.S. Ser. No. 10/765,523; “Techniques for Establishing and Managing a Distributed Credential Store,” filed on Jan. 29, 2004, and having the U.S. Ser. No. 10/767,884; and “Techniques for Establishing and Managing Trust Relationships,” filed on Feb. 3, 2004, and having the U.S. Ser. No. 10/770,677; all of which are commonly assigned to Novell, Inc., of Provo, Utah and the disclosures of which are incorporated by reference herein.

An identity service may also provide single sign-on services to a resource. That is, a resource may sign-on to an identity service and acquire identities and credentials to access a variety of other services or resources. In some cases, the identity service is modified or enhanced to perform some of the teachings presented herein and below.

A resource is recognized via an “identity.” An identity is authenticated via various techniques (e.g., challenge and response interaction, cookies, assertions, etc.) that use various identifying information (e.g., identifiers with passwords, biometric data, hardware specific data, digital certificates, digital signatures, etc.). A “true identity” is one that is unique to a resource across any context that the resource may engage in over a network (e.g., Internet, Intranet, etc.). However, each resource may have and manage a variety of identities, where each of these identities may only be unique within a given context (given service interaction, given processing environment, given virtual processing environment, etc.).

The identity may also be a special type of identity that the resource assumes for a given context. For example, the identity may be a “crafted identity” or a “semantic identity.” An example for creating and using crafted identities may be found in U.S. patent application Ser. No. 11/225,993; entitled “Crafted Identities;” filed on Sep. 14, 2005; and the disclosure of which is incorporated by reference herein. An example for creating and using semantic identities may be found in U.S. patent application Ser. No. 11/261,970; entitled “Semantic Identities;” filed on Oct. 28, 2005; and the disclosure of which is incorporated by reference herein.

Various embodiments of this invention can be implemented in existing network architectures, security systems, data centers, and/or communication devices. Any particular architectural layout or implementation presented herein is provided for purposes of illustration and comprehension only and is not intended to limit aspects or embodiments of the invention.

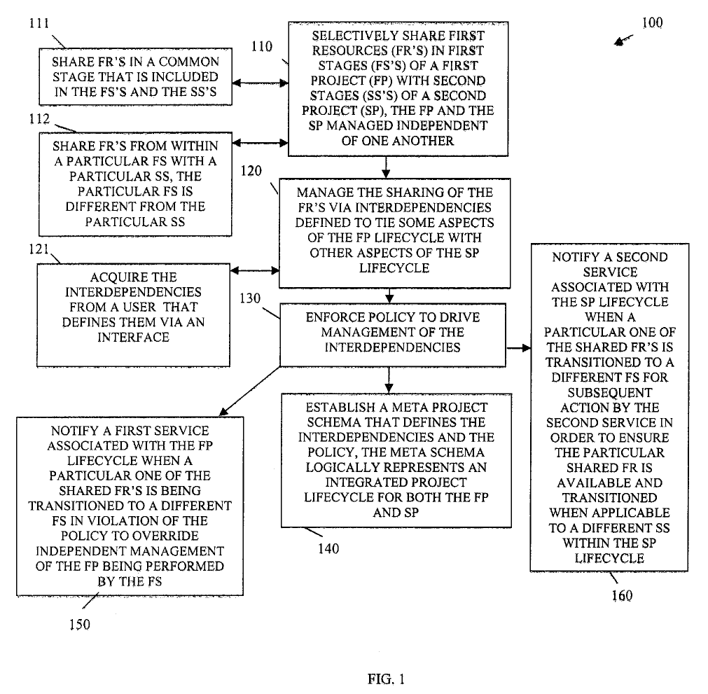

It is within this context, that various embodiments of the invention are now presented with reference to the FIGS. 1-4.

FIG. 1 is a diagram of a method 100 for sharing a resource across multiple independent project lifecycles, according to an example embodiment. The method 100 (hereinafter “project resource sharing service”) is implemented as instructions in a machine-accessible and readable medium. The instructions when executed by a machine perform the processing depicted in FIG. 1. The project resource sharing service is also operational over and processes within a network. The network may be wired, wireless, or a combination of wired and wireless.

Initially, a first project having a first project lifecycle that has a plurality of first stages within that lifecycle is identified. The first project includes a plurality of first resources. Additionally, a second project having a second project lifecycle, which also has a plurality of second stages within that lifecycle, is identified. The first and second project lifecycles are independently managed from one another. Thus, some first resources transition from various first stages of the first project lifecycle to other first stages of the first project lifecycle in accordance with policy. Again, the two projects are self contained and managed independent of one another.

At 110, the project resource sharing service selectively shares a number of the first resources, which are associated with the first stages of the first project's lifecycle with second stages of the second project's lifecycle. A resource can be shared in a variety of manners. For example, if the resource is a storage device, then certain storage may be set aside for use by second stages of the second project's lifecycle. As another example, if the resource is a software application, then the software application, such as a reporting service may be used by second stages of the second project's lifecycle while it is simultaneously accessed and used by first stages of the first project's lifecycle. Proper access permissions and configurations on the shared resources are established in advance of the resource being shared.

In an embodiment, at 111, the project resource sharing service may permit the sharing of the first resources when the first resources are associated with a common stage in both the first project and second project's lifecycle. For example, suppose the first resource is a proxy machine that provides firewall protection from the Internet. Suppose further that during a testing phase (particular first stage) of an email-based project (first project) the proxy is used for facilitating secure access to a web page embedded as a link within an email to ensure the link is working properly and is authentic. Simultaneously, a web-hosting project (second project) in a testing phase (particular second stage) has a need to use the proxy to interact with external Internet clients, which are authenticated or authorized. Both projects (email and web hosting) are independently managed and each have project lifecycle stages, the proxy (shared resource) is shared from a common stage associated with each project, which in this case is a testing stage or phase.

According to another embodiment, at 112, the project resource sharing service may permit the sharing of the first resources when the first resources are associated with a particular first stage of the first project's lifecycle and a particular entirely different second stage of the second project's lifecycle. The particular first stage and the particular second stage are different from one another. So, in the example presented above the first stage may be associated with testing in the email-based project and the second stage may be associated with development in the web-hosting project.

At 120, the project resource sharing service dynamically and in real time manages the sharing of the first resources via interdependencies defined for tying some aspects of the first project lifecycle with other aspects of second project lifecycle. In other words, a variety of conditions may be defined that instruct the project resource sharing service as to when to permit and not permit the sharing of the first resources and when actions may be needed within the first project lifecycle or the second project lifecycle.

For example, in the example presented above the proxy (shared first resource) may not be permitted to be shared with the web-hosting project (second project) within the production phase (particular second stage of the second project's lifecycle), since an enterprise may want a dedicated and standalone reverse proxy for its production release of the web-hosting project. Thus, an interdependency may be defined that permits the project resource sharing service to recognize this and prevent it from occurring. Similarly, access permissions for other resources (such as users) that utilize the shared resource may be identified, referenced, or defined in the interdependencies. So, the users permitted to access a shared resource may vary from the first project to the second project. Still further, configurations may be changed or altered in the first stage for the shared resource from that which appears in the second stage for the shared resource and these configuration details may be referenced, identified, or defined in the interdependencies.

The two projects are still independently managed by their own project management lifecycle services; but the project resource sharing service superimposes meta management on top of two projects and monitors their management and then utilizes the interdependencies to permit resource sharing between the stages of the two independent projects in a dynamic, real time, and automated fashion.

In an embodiment, at 121, the project resource sharing service acquires the interdependencies from a user that defines them via an interface. So, a user, such as an administrator, can access an Application Programming Interface (API) to define interdependencies for sharing first resources between two independent projects. These interdependencies may then be stored in a repository or associated with an identity of the shared resources or the projects for subsequent identification and retrieval by the project resource sharing service.

At 130, the project resource sharing service also enforces policy to drive the management of the interdependencies. That is, the interdependencies may identify or be linked based on identity or some other mechanism to one or more policies. The policies define further conditions that the project resource sharing service is to follow when facilitating resource sharing between independent projects. In this manner, groupings of projects or resources can have meta conditions defined on a more global basis via policy definition. This permits the project resource sharing service to manage a variety of shared resources and permits certain interdependency conditions to be overridden by policy.

For example, suppose the proxy (shared resource in the above example) is scheduled for an upgrade on a certain date and time or is updated every night during a certain time frame. Policy may prohibit any sharing of the proxy during these periods of time. It is noted that the interdependencies may themselves include some of the policies and that in other cases the policies may be entirely independent and separate from the defined interdependencies.

According to an embodiment, at 140, the project resource sharing service initially establishes a meta project schema that defines the interdependencies and the policy. The meta schema is a data structure that logically represents an integrated project lifecycle for both the first project lifecycle and the second project lifecycle. So, two entirely independent and self managed projects having their own project lifecycles can be unknown to them and their processes be combined in user-defined manners in a meta integrated project that facilitates the coordination and management of shared resources. This can be done by encapsulating the interdependencies and policies in a meta project schema.

In an embodiment, the format of the meta project schema may be in presentation independent format, such as extensible markup language (XML) format and embodied as a XML schema definition (XSD). Of course it is understood the embodiments presented herein are not tied to any specific data formats as any will work as long as they are consistent and as long as the project resource sharing service is configured to recognize, parse, and process the data formats.

In another situation, at 150, the project resource sharing service may also be configured to directly or indirectly interact with a first service that manages the first project lifecycle of the first project. In such a case, the project resource sharing service can notify the first service when a particular one of the shared first resources is being transitioned within the first stages of the first project lifecycle to a different first stage in violation of a policy known to the project resource sharing service. This overrides the first service's independent management of the first project with respect to the shared resource.

In a similar case, at 160, the project resource sharing service may be configured to directly or indirectly interact with a second service that manages the second project lifecycle of the second project. Here, the project resource sharing service may be used as an intermediary between the two independent projects and notify the second service when a particular first resource being shared is transitioned to a different first stage of the first project's lifecycle. This can ensure that the second service take action to account for the first project's transition and still available for use in the second project's processing environment. Thus, the second service may want to drive a transition within the second project's processing environment to account for the resource transition that occurred within the first project's processing environment or the second service may want to reconfigure the shared resource within the second project's processing environment. The project resource sharing service facilitates needed actions by notifying the second service.

One now appreciates how two independent projects each having independent stages of their own project lifecycles and each having their own independent processing environments can share resources in an automated and controlled fashion.

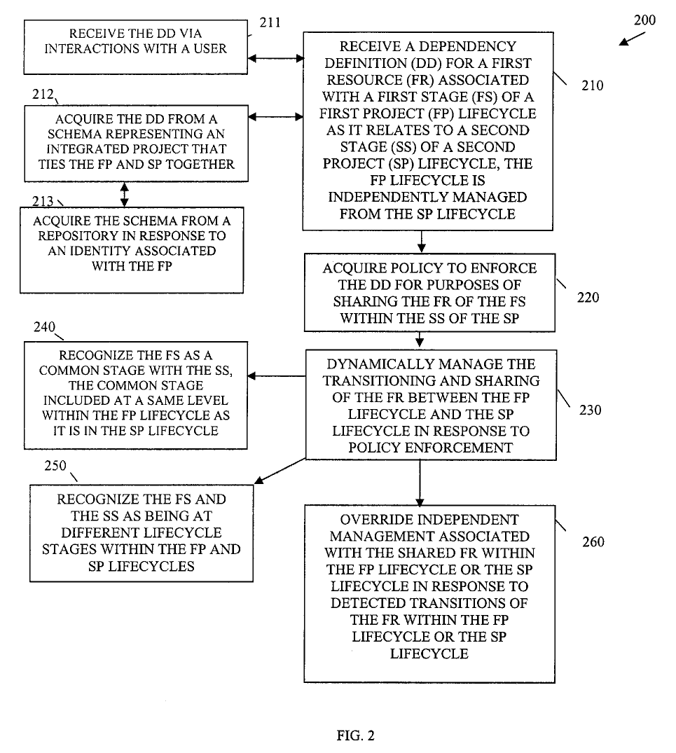

FIG. 2 is a diagram of another method 200 for sharing a resource across multiple independent project lifecycles, according to an example embodiment. The method 100 (hereinafter “project sharing service”) is implemented as instructions in a machine-accessible and readable medium. The instructions when executed by a machine perform the processing depicted in FIG. 2. The project sharing service is also operational over and processes within a network. The network may be wired, wireless, or a combination of wired and wireless.

The processing associated with the project sharing service represents an alternative and in some case enhanced perspective of the processing described above with reference to the method 100 of the FIG. 1.

At 210, the project sharing service receives a dependency definition for a first resource. The first resource is associated with a first stage of a first project and its lifecycle. The dependency definition defines the sharing conditions of that first resource in the first stage with a second stage of a second project and that second project's lifecycle. The two projects do not have to be related in any manner; although they can be in some instances. However, the two projects are independently managed via their own processing environments and their own project lifecycles.

According to an embodiment, at 211, the project sharing service receives the dependency definitions via interactions with a user. It may also be the case that the dependency definitions were previously user-defined and retrieved by the project sharing service from a service, such as an identity service (defined and incorporated by reference above) or a repository.

In yet another situation, at 212, the project sharing service acquires the dependency definition initially from a schema. The schema is a data structure that represents an integrated project that ties the first project together with the second project via a meta project definition. At 213, the project sharing service acquires the schema from a repository in response to an identity associated with or identified with the first project or even the second project. It may also be the meta project has a unique identity that permits the schema to be acquired from the repository by the project sharing service and from the schema the identity of the first project and second project is acquired.

Example dependency definitions were discussed in detail above with reference to the interdependencies described within the context of the method 100 of the FIG. 1. Similarly, the schema data structure was discussed above with reference to the method 100 of the FIG. 1.

At 220, the project sharing service acquires policy to enforce the dependency definitions. The policy permits the project sharing service to acquire instructions, configurations, access permissions, etc. to share the first resource with the second stage of the second project's lifecycle. Although policy is used in a singular sense herein, it is to be understood that multiple policies may be acquired and used. Additionally, the policies may be hierarchical in nature meaning that some policies include other policies and some policies trump or override other policies. Still further, the policies may be partially acquired from the dependency definitions and/or may be acquired entirely independent of the dependency definitions. Example usage of the policy was described in detail above with reference to the method 100 of the FIG. 1.

At 230, the project sharing service dynamically and in real time manages the transitioning and sharing of the first resource between the first project's lifecycle and the second project's lifecycle in response to the policy enforcement. So, as the first resource is being independently managed within a first processing environment and within a first stage of the first project, the project sharing service monitors or detects events that are interpreted in view of the policy to change or alter how the first resource is being handled within a second processing environment associated with a second project's lifecycle. This dynamic and real time processing is overlaid on top of the two projects, which are independently managing separate projects. The project sharing service acts as an intermediary that may or may not be known to the services that manage the two projects.

That is, an Application Programming Interface (API) may permit the project sharing service to directly force actions and instructions in the project lifecycles of the two projects to enforce the policy and the dependency definitions. Alternatively, the project sharing service may take an action via a third-party service or on its own that forces project managing services of the two project's to take action and this can occur without the two project managing services even being aware of the existence of the project sharing service.

For example, suppose a first resource (such as the proxy used in the example presented above with the method 100) is being shared between the email project and the web hosting project. The email project management service of the email project may shut down the proxy when the project transitions to production unless the proxy affirmatively informs the email project management service that this is not to occur. A web hosting project management service is not even aware of the email project or the project sharing service, but it is actively using the proxy in a testing stage of the web hosting when the email project management service transitions to production. In this example, the project sharing service issues an instruction that just the proxy responds to that instructs the proxy to inform the email project management service that the proxy is not to be shut down. This communication between the project sharing service and the proxy may be achieved by simply changing a processing or configuration parameter of the proxy that the project sharing service has permission to do, so the proxy may not even be aware of the project sharing service. The project sharing service in this example as effectively coordinated the continued use of the proxy in a fashion that is unknown and independent of the two separate processing environments that are each using the proxy. It is understood that this is but one example, which was presented for purposes of illustration and that many more complex and sophisticated scenarios may be achieved via the project sharing service; some using directed and known interactions and others using unknown and indirect interactions as described above.

In an embodiment, at 240, the project sharing service recognizes the first stage as being a common stage with the second stage that is sharing the first resource. That is, the first stage is at a same project lifecycle stage level in the first project lifecycle when it is shared as it is in the second project lifecycle. In such a case, the project lifecycles may be defined independent of any particular project, such as development, testing, quality assurance, release, production, etc. and the first resource is shared from a same or common stage between the two independent project lifecycles.

In a different situation, at 250, the project sharing service recognizes the first stage and the second stage that share the first resource as being at entirely different lifecycle stages within the first and second projects' lifecycles. Here, the first and second projects' lifecycles may or may not be independent of the project. That is, the stages of the first project may be entirely different from defined stages of the second project. Alternatively, the stage of the first project may be testing and the stage of the second project maybe development when the lifecycles are similarly defined and independent of any particular project.

According to an embodiment, at 260, the project sharing service can override independent management associated with the shared first resource within the first project's life cycle or the second project's lifecycle. This can be achieved in response to detected transitions of the first resource occurring within the first processing environment of the first project's lifecycle or occurring within the second processing environment of the second project's lifecycle. This processing can be direct or indirect as discussed at length above with reference to the processing of 230.

It is now appreciated how two independently managed projects can share resources via the processing associated with the project sharing service. Meta integrated projects can be superimposed on the two independent projects and the project sharing service acts as an intermediary to facilitate resource sharing according to dependency definitions and policy enforcement.

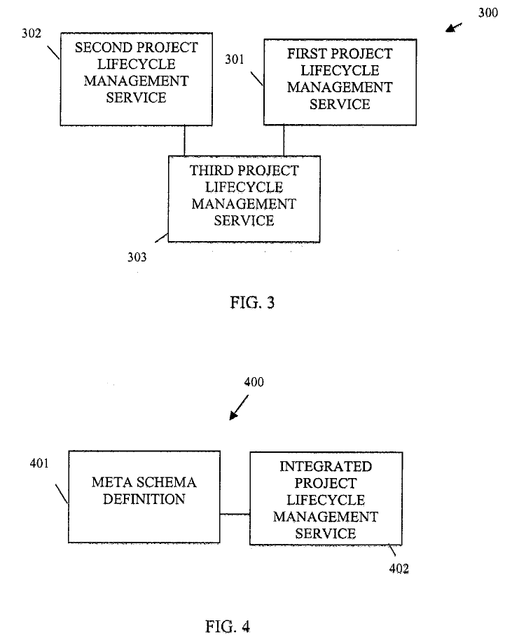

FIG. 3 is a diagram of an inter-project resource sharing management system 300, according to an example embodiment. The inter-project resource sharing management system 300 is implemented as instructions on or within a machine-accessible and readable medium. The instructions when executed by a machine perform various aspects of the processing depicted with respect to the methods 100 and 200 of the FIGS. 1 and 2, respectively. The inter-project resource sharing management system 300 is also operational over a network and the network may be wired, wireless, or a combination of wired and wireless.

The inter-project resource sharing management system 300 includes a first project lifecycle management service 301, a second project lifecycle management service 302, and a third project lifecycle management service 303. Each of these components and their interactions with one another will now be discussed in turn.

The first project lifecycle management service 301 is implemented in a machine-accessible and readable medium as instructions that when accessed by a machine and processed performs automated project management for a first project having a first project lifecycle. The first project lifecycle includes a variety of first stages that define the first project lifecycle. Each of the first stages can include its own independently configured first processing environment.

The second project lifecycle management service 302 is implemented in a machine-accessible and readable medium as instructions that when accessed by a machine and processed performs automated project management for a second project having a second project lifecycle. The second project lifecycle includes a variety of second stages that define the second project lifecycle. Again, each of the second stages can include its own independently configured second processing environment.

In an embodiment, the first project lifecycle management service 301 and the second project lifecycle management service 302 are different configured instances of a same project lifecycle management service, each instance designed to independently manage one of the two projects and its lifecycle.

The two projects managed by the first and second project lifecycle management services 301 and 302 may or may not be related to a similar project but each independently manage their own project from within their own processing environments.

The third project lifecycle management service 303 is implemented in a machine-accessible and readable medium as instructions that when accessed and processed by a machine performs processing depicted in FIGS. 1 and 2 and described with reference to the methods 100 and 200 above.

Specifically, the third project lifecycle management service 303 is to manage sharing selective ones of first resources, which are associated with the first project's lifecycle, and/or second resources, which associated with the second project's lifecycle, between the first project and the second project.

In an embodiment, the sharing of the selective resources occurs within a common stage to both the first stage of the first project and the second stage of the second project. In a different case, the sharing of the selective resources occurs within a different stage in the first stages from that of the second stages.

The third project lifecycle management service 303 monitors transitions of the selective shared resources occurring within the first and second project lifecycles and their native processing environments. This monitoring may be achieved directly or indirectly via a notification service or event service. It may even be acquired by just monitoring the particular resources being shared.

The third project lifecycle management service 303 directly or indirectly interacts with the first project lifecycle management service 301 and the second project lifecycle management service 302. This is done to drive a transition of any shared resource within one project lifecycle when the third project lifecycle management service 303 detects the same shared resource has transitioned within the other project lifecycle.

The third project lifecycle management service 303 may also dynamically override management occurring with the selective shared resources within their native project lifecycle processing environments. This is done via direct or indirect communication or instruction to the first project lifecycle management service 301 and/or the second project lifecycle management service 302.

FIG. 4 is a diagram of another inter-project resource sharing management system 400, according to an example embodiment. The inter-project resource sharing management system 400 is implemented as instructions on or within a machine-accessible and readable medium. The instructions when executed by a machine perform various aspects of the processing depicted with respect to the methods 100 and 200 of the FIGS. 1 and 2, respectively, and processing associated with the system 300 of the FIG. 3. The inter-project resource sharing management system 400 is also operational over a network and the network may be wired, wireless, or a combination of wired and wireless.

The inter-project resource sharing management system 400 presents an alternative architecture and arrangement of components from that which was presented with the inter-project resource sharing management system 300 of the FIG. 3.

The inter-project resource sharing management system 400 includes a meta schema definition 401 and an integrated project lifecycle management service 402. Each of these components and their interactions with one another will now be discussed in turn.

The meta schema definition 401 is implemented in a machine-accessible and readable medium and is accessible to one or more machines. The meta schema definition 401 included dependencies between at least two projects and their project lifecycles. In some cases, the dependencies identify one or more first stages associated a first of the two independent projects for which resources are being shared along with one or more second stages associated with a second of the two independent projects. Additionally, the dependencies may be user-defined or user-supplied.

These dependencies were discussed at length above with reference to the methods 100 and 200 of the FIGS. 1 and 2, respectively.

The meta schema definition 401 may also include one or more policies that provide processing instructions and directives to the integrated project lifecycle management service 402 for purposes of sharing resources between the two projects and their independently managed project lifecycles.

The stage management service 402 is implemented in a machine-accessible and readable medium and is to process on the one or more machines.

The integrated project lifecycle management service 402 may assist in initially building and populating the meta schema definition 401, although this does not have to always be the case as other interfaces may be used to do this. The integrated project lifecycle management service 402 interprets the meta schema definition 401 to logically manage the two independent projects as a meta integrated project for purposes of sharing resources between the two projects. This is done by monitoring the resources and/or the processing environments of the two projects and taking actions defined by conditions associated with the dependencies and/or the policies. The processing that can take place to achieve this was discussed at length above with reference to the methods 100 and 200 of the FIGS. 1 and 2, respectively.

One of ordinary skill in the art now appreciates how resources may be better utilized and managed across multiple independent project lifecycles. This can reduce resource duplication and increase resource utilization. This can also reduce support and maintenance expenses for an enterprise without decreasing project quality or compromising project security.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
selectively sharing first resources associated with one or more first stages of a first project with one or more second stages of a second project, wherein the first stages are associated with a first project lifecycle of the first project and the second stages are associated with a second project lifecycle of the second project and each of the projects are managed independent of one another;
managing the sharing of the first resources via interdependencies defined for tying some aspects of the first project lifecycle with other aspects of the second project lifecycle; and
enforcing policy to drive the management of the interdependencies.

2. The method of claim 1 further comprising, establishing a meta project schema that defines the interdependencies and the policy, wherein the meta project schema logically represents an integrated project lifecycle for both the first project and the second project.

3. The method of claim 1, wherein selectively sharing further includes sharing the first resources in a common stage, which is included in the first stages and the second stages.

4. The method of claim 1, wherein selectively sharing further includes sharing the first resources from within a particular first stage of the first stages with a particular second stage of the second stages, and wherein the particular first stage is different from the particular second stage.

5. The method of claim 1, wherein managing further includes acquiring the interdependencies from a user that defines them via an interface.

6. The method of claim 1 further comprising, notifying a first service associated with the first project lifecycle when a particular one of the shared first resources is being transitioned to a different first stage in violation of the policy to override independent management of the first project being performed by the first service.

7. The method of claim 1 further comprising, notifying a second service associated with the second project lifecycle when a particular one of the shared first resources is transitioned to a different first stage for subsequent action by the second service in order to ensure the particular shared first resource is available and transitioned when applicable to a different second stage within the second project lifecycle.

8. A method, comprising:
receiving a dependency definition for a first resource associated with a first stage of a first project lifecycle as it relates to a second stage of a second project lifecycle, wherein the first project lifecycle is for a first project that is independently managed from that of a second project, which is associated with the second project lifecycle;
acquiring policy to enforce the dependency definition for purposes of sharing the first resource in the first stage of the first project lifecycle within the second stage of the second project lifecycle; and
dynamically managing the transitioning and sharing of the first resource between the first project lifecycle and the second project lifecycle in response to the policy enforcement.

9. The method of claim 8 further comprising, recognizing the first stage as a common stage with the second stage, wherein the common stage is included and at a same level within the first project lifecycle as it is in the second project lifecycle.

10. The method of claim 8 further comprising, recognizing the first stage and second stage as being at different lifecycle stages within the first project lifecycle and the second project lifecycle.

11. The method of claim 8 further comprising, overriding independent management associated with the shared first resource within the first project lifecycle or the second project lifecycle in response to detected transitions of the first resource within the first project lifecycle or the second project lifecycle.

12. The method of claim 8, wherein receiving further includes receiving the dependency definition via interactions with a user.

13. The method of claim 8, wherein receiving further includes acquiring the dependency definition from a schema representing an integrated project that ties both the first project and the second project together.

14. The method of claim 13 further comprising, acquiring the schema from a repository in response to an identity of the first project.

15. A system, comprising:
a first project lifecycle management service implemented in a machine-accessible and readable medium and to process on a machine;
a second project lifecycle management service implemented in a machine-accessible and readable medium and to process on a machine; and
a third project lifecycle management service implemented in a machine-accessible and readable medium and to process on a machine, wherein the first project lifecycle management service is to manage a first project lifecycle of first resources associated with a first project, and the second project lifecycle management service is to independently manage a second project lifecycle of second resources associated with a second project of the second project lifecycle, selective ones of the first resources and the second resources between the first and second project lifecycles.

16. The system of claim 15, wherein the first project lifecycle is defined by first stages and the second project lifecycle is defined by second stages and wherein the sharing of the selective first and second resources occurs within a common stage to both the first stages and the second stages.

17. The system of claim 15, wherein the first project lifecycle is defined by first stages and the second project lifecycle is defined by second stages and wherein the sharing of the selective first and second resources occurs within a different stage in the first stages from that of the second stages.

18. The system of claim 15, wherein the third project lifecycle management service is to dynamically override management of the selective first and second resources within the first or second project lifecycles via communication with the first or second project lifecycle management services in response to policy.

19. The system of claim 15, wherein the third project lifecycle management service is to monitor transitions of the selective first and second resources occurring within the first and second project lifecycles.

20. The system of claim 15, wherein the third project lifecycle management service is to interact with the second project lifecycle management service to drive a transition of a shared resource within the second project lifecycle when the third project lifecycle management service detects the shared resource has transitioned within the first project lifecycle management service.

21. A system, comprising:
a meta schema definition for an integrated project, wherein the meta schema definition is implemented in a machine-accessible and readable medium and is accessible to one or more machines; and
an integrated project lifecycle management service implemented in a machine-accessible and readable medium and to process on the one or more machines, wherein the integrated project lifecycle management service uses the meta schema definition to acquire dependencies between two independent projects and their lifecycles for purposes of managing the sharing of resources between the two independent projects during the course of their lifecycles.

22. The system of claim 21, wherein the meta schema definition also includes one or more policies that provide instructions and processing direction to the integrated project lifecycle management service.

23. The system of claim 21, wherein the integrated project lifecycle management service is to monitor or interact with two independent project lifecycle management services, each independent project lifecycle management service responsible for managing one of the two independent projects and its lifecycle.

24. The system of claim 21, wherein at least a portion of a particular dependency identifies one or more first stages associated with a first of the two independent projects for which the resources are to be shared along with one or more second stages associated with a second of the two independent projects.

25. The system of claim 21, wherein the dependencies are user-defined.
